(19) United States
(12) Patent Application Publication
(10) Pub. No.: US 2018/0039608 A1
(43) Pub. Date: Feb. 8, 2018

(54) CORRECTION OF PREVIOUSLY RECEIVED TEXTUAL MESSAGES BASED ON ONE OR MORE LATER RECEIVED TEXTUAL MESSAGES

(71) Applicant: Google Inc., Mountain View, CA (US)

(72) Inventors: Matthew Sharifi, Kilchberg (CH); Jakob Nicolaus Foerster, Zurich (CH)

(73) Assignee: Google Inc., Mountain View, CA (US)

(21) Appl. No.: 15/227,598

(22) Filed: Aug. 3, 2016

(51) Int. Cl. G06F 17/24; G06F 17/25; G06F 17/27

(52) U.S. Cl. CPC G06F 17/24; G06F 17/273; G06F 17/25

(57) ABSTRACT

A computer-executed technique for correcting previously received textual messages based on a later received textual message can include receiving and displaying a first textual message in a user interface. A second textual message is received and, based on this second textual message, the first textual message is analyzed to determine if it includes a correctable error. When the first textual message is determined to include an error, a language model is utilized to determine an incorrect word therein. A corrected word is programmatically determined and is used to automatically replace the incorrect word to generate a corrected first textual message. The user interface is modified such that the corrected first received textual message replaces the first received textual message.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In typical communication applications, a textual message (such as an instant message, short message service message, or social network message/posting) is presented as it is received. Thus, if a sending user sends a textual message that contains an error to a receiving user, the receiving user will be presented with the textual message and may or may not detect the error. The sending user may wish to correct the error, if the error is noticed by the sending user. For example, the sending user may send a second, corrected version of the textual message (or portion thereof), which would then be displayed after the original textual message. This may confuse the receiving user, and also increases the length of the record of the textual message conversation.

### SUMMARY

According to various implementations of the present disclosure, a technique for correcting previously received instant messages can include receiving, at a computing device executing an instant messaging application, a first received instant message from a sender user at a first time. The first received instant message can include one or more words. The technique can further include displaying, at the computing device, the first received instant message in a user interface of the instant messaging application. Additionally, a second received instant message can be received at the computing device from the sender user at a second time after the first time. The technique can also include determining, at the computing device and based on the second received instant message, if the first received instant message includes a correctable error.

When the first received instant message includes the correctable error, the techniques can include: (i) utilizing, at the computing device, a language model to analyze each word of the one or more words of the first received instant message based on the second received instant message to determine an incorrect word to be corrected; (ii) determining, at the computing device and based on the second received instant message, a corrected word to replace the incorrect word; (iii) replacing, at the computing device, the incorrect word in the first received message with the corrected word to obtain a corrected first received instant message; and (iv) modifying, at the computing device, the user interface such that the corrected first received instant message replaces the first received instant message.

A computing device for correcting previously received instant messages is also presented. The computing device can include one or more processors, and a non-transitory computer-readable storage medium having a plurality of instructions stored thereon, which, when executed by the one or more processors, cause the one or more processors to perform operations.

The operations can include executing an instant messaging application and receiving a first received instant message from a sender user at a first time. The first received instant message can include one or more words. The operations can further include displaying the first received instant message in a user interface of the instant messaging application. Additionally, a second received instant message can be received at the computing device from the sender user at a second time after the first time. The operations can also include determining, based on the second received instant message, if the first received instant message includes a correctable error.

When the first received instant message includes the correctable error, the operations can include: (i) utilizing a language model to analyze each word of the one or more words of the first received instant message based on the second received instant message to determine an incorrect word to be corrected; (ii) determining, based on the second received instant message, a corrected word to replace the incorrect word; (iii) replacing the incorrect word in the first received message with the corrected word to obtain a corrected first received instant message; and (iv) modifying the user interface such that the corrected first received instant message replaces the first received instant message.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system including an example computing device and an example server and according to some implementations of the present disclosure;

FIG. 2 is a functional block diagram of the example computing device of FIG. 1;

FIGS. 3A-3D are diagrams of example graphical user interfaces according to some implementations of the present disclosure;

FIGS. 4A-4D are diagrams of example graphical user interfaces according to some implementations of the present disclosure;

FIGS. 5A-5D are diagrams of example graphical user interfaces according to some implementations of the present disclosure;

FIGS. 6A-6D are diagrams of example graphical user interfaces according to some implementations of the present disclosure;

FIG. 7 is a flow diagram of an example technique for determining when a first received textual message includes a correctable error according to some implementations of the present disclosure; and

FIG. 8 is a flow diagram of an example technique for correcting previously received textual messages based on a later received textual message according to some implementations of the present disclosure.

### DETAILED DESCRIPTION

Textual messages (instant messages, short message service messages, social network messages/postings, etc.) are presented as they are received in typical communication applications. Thus, if a sending user sends a textual message that contains an error to a receiving user, the receiving user will be presented with the textual message and may or may not detect the error. The sending user may wish to correct the error, if the error is noticed by the sending user. For example, the sending user may send a second, corrected version of the textual message (or portion thereof), which would then be displayed after the original textual message. This may confuse the receiving user, and also increases the length of the record of the textual message conversation. Thus, textual messages that contain errors (typos, misspellings, etc.) will be displayed permanently in the record of the textual messaging conversation, even if the sending user attempts to correct the error later, e.g., by sending a corrected textual message. In addition to making the conversation record longer, this also clutters the user interface with multiple copies of the same textual message or portion thereof with minor changes.

An example of the deficiencies of the typical communication application is illustrated in the following instant message conversation between a sending user and a receiving user. The sending user sends a first instant message stating “Can you send me a picture of your bat?” at a first time (time t). The sending user, noticing that the word “bat” was included in error because the word “cat” was intended instead, sends a second instant message “of your cat” at a second time (time t+1). In a typical instant messaging application, the first and second instant messages described above may be displayed in the graphical user interface (“GUI”) of the instant messaging application as follows:

Can you send me a picture of your bat?
first instant message at time t

of your cat
second instant message at time t+1

In this example, the sending user noticed the error in the first instant message, and entered a second instant message that involved re-entering a portion of the first instant message with a corrected word (“cat”) in place of the incorrect word (“bat”). The receiving user may be confused upon reading the first instant message and before reading the second instant message, which attempts to clarify the meaning of the first instant message. Not only must the receiving user read both of the first and second instant messages and infer what the sending user is intending to communicate, but also there will be a permanent record of the error in the conversation record. Given the fast pace of such instant message conversations, it would be desirable to provide a quicker and more efficient process for correcting the first instant message, as well as for presenting the corrected second instant message to the receiving user.

The present disclosure is directed to, inter alia, the technical problem of correcting and displaying textual messages. More specifically, the present disclosure is directed to techniques for correcting previously sent/received textual messages. The techniques utilize a language model to analyze a first textual message based on a later received second textual message to correct an error (if any) in the first textual message. In some cases, the second textual message is an explicit attempt by the sending user to correct the previously sent first textual message. Additionally or alternatively, the techniques can be utilized to correct a previously sent first textual message that—based on a later sent second textual message—is determined to contain an error without such an explicit correction attempt by the sending user.

Upon determining that the first textual message contains an error, the techniques of the present disclosure provide for utilizing a language model to determine an incorrect word in the first textual message corresponding to the error. A corrected word for that incorrect word is also determined based on the second textual message. A corrected word can include, but is not limited to, a word, a partial word, a plurality of words, an acronym, a shortened or informal form of a word or words (e.g., “thx” or “thnks” to represent the word “thanks” or “thnk u” to represent “thank you”), a punctuation mark or other non-alphabetic character (e.g., a question mark to replace an incorrectly input exclamation point), and even an absence of a character/blank space (e.g., if a word is entered twice, as in “thank thank you,” a corrected word could be deleting one instance of the duplicated word). A corrected first textual message can be generated in which the corrected word replaces the incorrect word. The user interface can then display the corrected first textual message instead of the originally received first textual message. Accordingly, the receiving user can be presented with the corrected first textual message. Depending on the content of the second textual message, the second textual message may be utilized solely for correcting the first textual message and never be displayed in the user interface. In other cases, the second textual message may be displayed—persistently or temporarily—in the user interface. In some implementations, an indicator can also be displayed in the user interface to indicate that a correction has been made.

In this manner, the present disclosure may provide one or more benefits, including, but not limited to, reducing confusion of the receiving user and a cleaner, less cluttered user interface for a communication application. For ease of description, the techniques of the present disclosure will be described in the context of an instant messaging application that sends and receives instant messages. It should be appreciated, however, that the present disclosure is directed to any type of communication application that is utilized to transmit, post, etc. textual messages, including, but not limited to, an instant messaging application, a social network, a bulletin board or other message posting service/website.

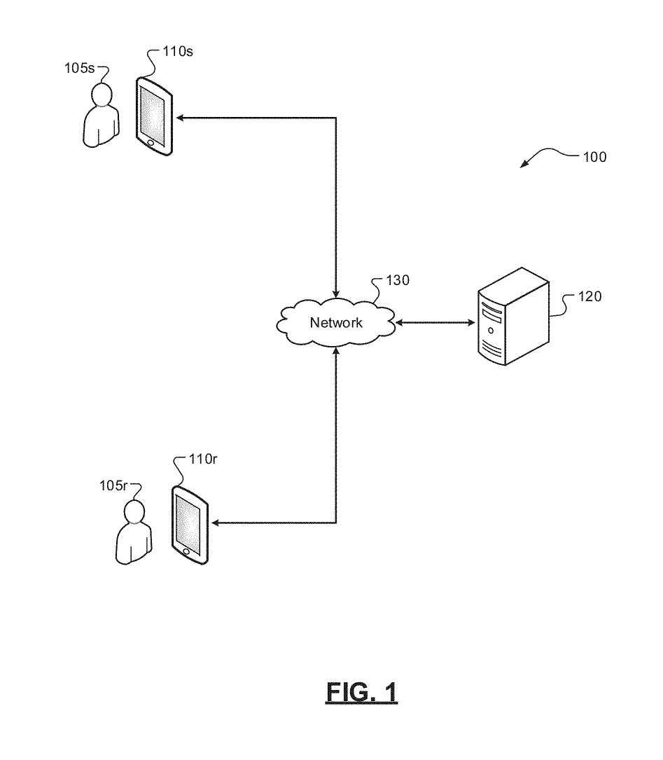

Referring now to FIG. 1, a diagram of an example computing system 100 is illustrated. The computing system 100 can be configured to implement an instant messaging communication network amongst a plurality of users via their computing devices. The computing system 100 can include a plurality of example computing devices 110 and an example server 120 that communicate via a network 130 according to some implementations of the present disclosure.

For ease of description, in this application and as shown in FIG. 1, two example computing devices 110 are illustrated and described: a sending computing device 110s that is associated with a sender user 105s, and a receiving computing device 110r that is associated with a receiving user 105r. It should be appreciated, however, that each of the computing devices 110s and 110r can both send and receive instant messages and, thus, can be described as the “sending” computing device or the “receiving” computing device (and, similarly, the “sending” user or the “receiving” user) depending on the circumstances and the particular instant message that is being discussed.

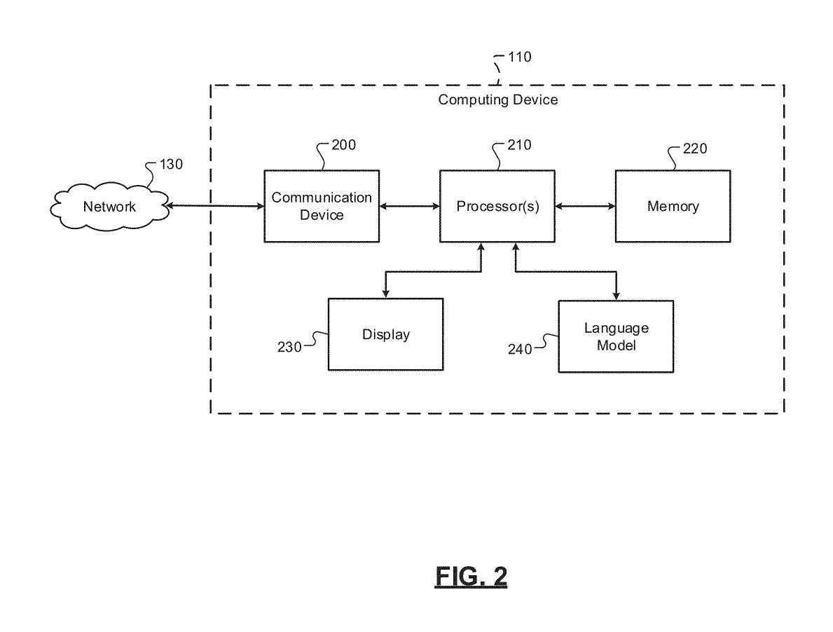

While illustrated as mobile phones (“smart” phones), each computing device 110 can be any type of suitable computing device, such as a desktop computer, a tablet computer, a laptop computer, a wearable computing device such as eyewear, a watch or other piece of jewelry, or clothing that incorporates a computing device. A functional block diagram of an example computing device 110 is illustrated in FIG. 2.

The computing device 110 can include a communication device 200, one more processors 210, a memory 220, a display device 230, and a language model 240. The processor(s) 210 can control operation of the computing device 110, including implementing at least a portion of the techniques of the present disclosure. The term “processor” as used herein is intended to refer to both a single processor and multiple processors operating together, e.g., in a parallel or distributed architecture.

The communication device 200 can be configured for communication with other devices (e.g., the server 120 or other computing devices 110) via the network 130. One non-limiting example of the communication device 200 is a transceiver, although other forms of hardware are within the scope of the present disclosure. The memory 220 can be any suitable storage medium (flash, hard disk, etc.) configured to store information. For example, the memory 220 may store a set of instructions that are executable by the processor 210, which cause the computing device 110 to perform operations, e.g., such as the operations of the present disclosure. The display device 230 can display information to the user 105. In some implementations, the display device 230 can comprise a touch-sensitive display device (such as a capacitive touchscreen and the like), although non-touch display devices are within the scope of the present disclosure.

A language model (such as language model 240) can be a probability distribution over a sequence of text (characters, word, phrases, etc.) that is derived from (or “trained” based on) training data. In some implementations, a language model can assign a probability to a piece of unknown text (character, word, phrase, etc.) based on the surrounding text (before and/or after the unknown text) and a corpus of training data upon which the language model is trained. The use of such a labeled training corpus or set can be referred to as a supervised learning process. The language model 240 can be utilized by the processor 210 to determine and correct an error in a received instant message, as more fully described below. Although illustrated as a separate element, it should be appreciated that the language model 240 can be partially or wholly implemented by processor 210 and/or the memory 220 (e.g., a database storing the parameters of the language model 240).

It should be appreciated that the example server computing device 120 can include the same or similar components as the computing device 110, and thus can be configured to perform some or all of the techniques of the present disclosure, which are described more fully below. Further, while the techniques of the present disclosure are described herein in the context of a computing device 110, it is specifically contemplated that each feature of the techniques may be performed by a computing device 110 alone, a plurality of computing devices 110 operating together, a server computing device 120 alone, a plurality of server computing devices 120 operating together, and a combination of one or more computing devices 110 and one or more server computing devices 120 operating together.

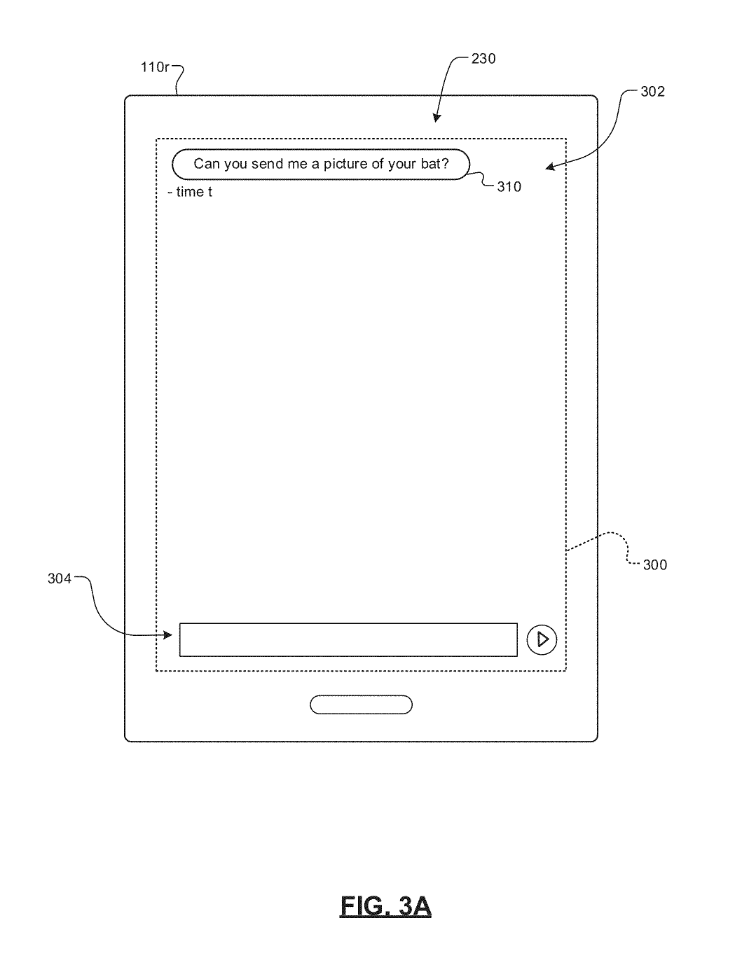

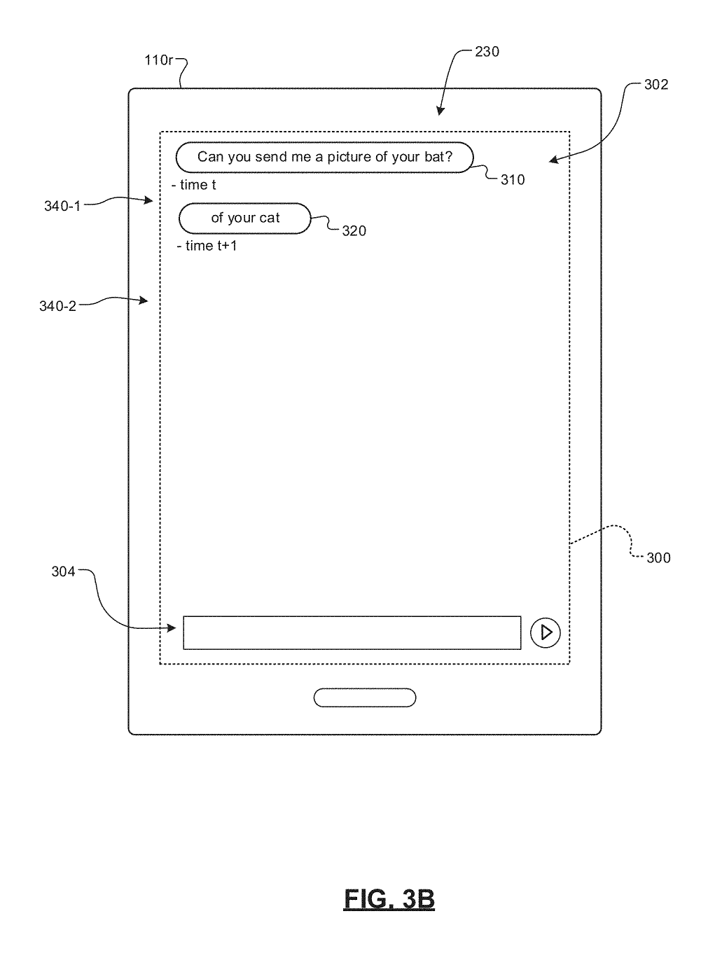

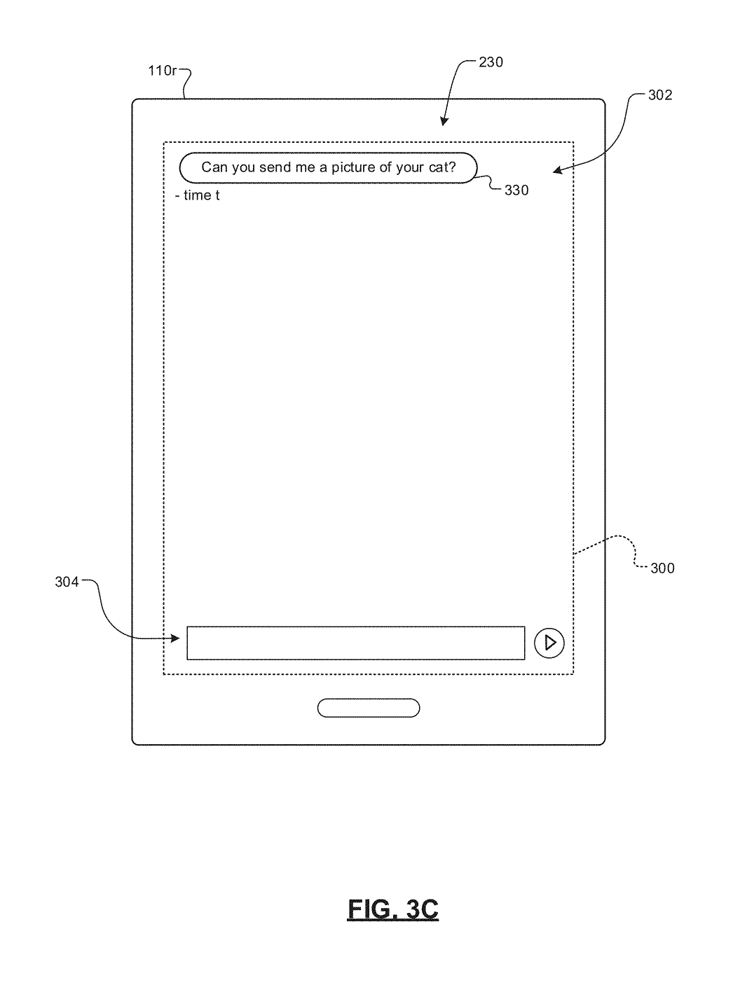

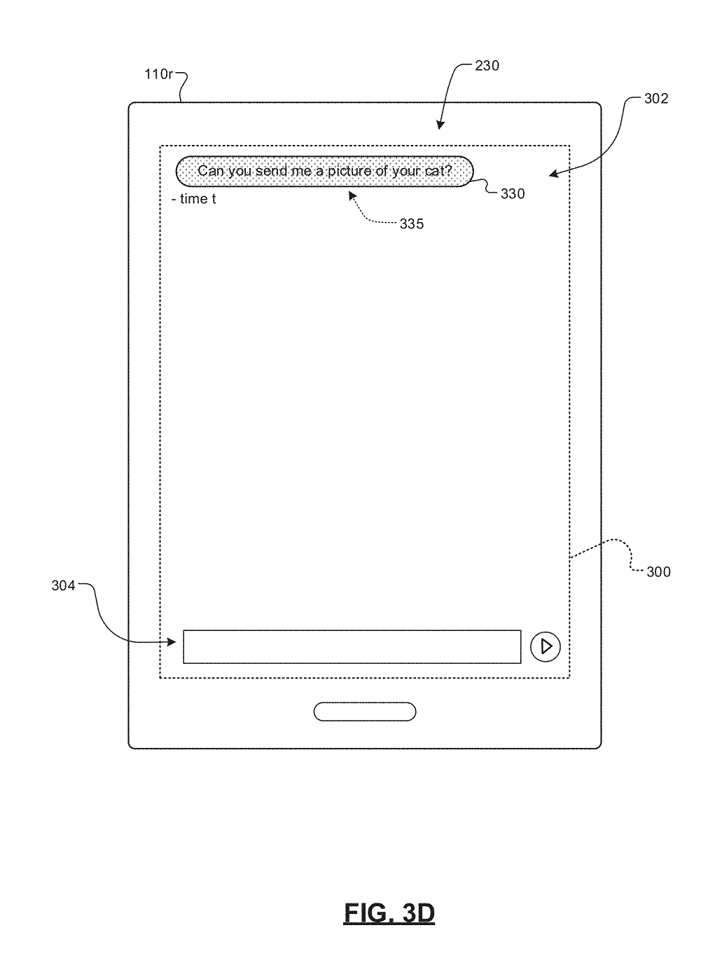

With reference to FIGS. 3A to 3D, an example GUI 300 that can be displayed by the display device 230 of the example receiving computing device 110r when executing an instant messaging application according to certain implementations of the present disclosure is shown. The illustrated GUI 300 includes an instant message display portion 302 and an instant message input portion 304. Instant messages that are sent or received can be displayed in the instant message display portion 302, and a user 105 can provide textual or other input in the instant message input portion 304, e.g., via a virtual keyboard (not shown) or other user input device.

A first received instant message 310 can be received by the receiving computing device 110r. The first received instant message 310 can include one or more words. In the illustrated example, the first received instant message 310 includes the text content “Can you send me a picture of your bat?” (see, e.g., FIG. 3A), which is associated with a timestamp of “time t” and was sent by the sending user 105s via the sending computing device 110s. The first received instant message 310 can be displayed in the instant message display portion 302. A receiving user 105r associated with the computing device 110r can read or otherwise perceive the text content of the first received instant message 310 (e.g., by hearing an audio output representative of the text content via a text-to-speech functionality).

The sending user 105s may have intended the first received instant message 310 to read “Can you send me a picture of your cat?” instead of “bat” as sent. Noticing that the first received instant message 310 contains an error (“bat” instead of “cat”), the sending user 105s may transmit a second instant message (second received instant message 320) that reads “of your cat” as shown in FIG. 3B. In order for the receiving user 105r to correctly understand the first received instant message 310 as intended by the sending user 105s, the receiving user 105r must read both the first and second received instant messages 310, 320, deduce that the second received instant message 320 is intended as a correction to the first received instant message 310, and, in essence, replace the incorrect content (“bat”) of the first received instant message 310 with the corrected content (“cat”) in the second received instant message 320.

In accordance with implementations of the present disclosure, the receiving computing device 110r will receive and display the first received instant message 310 in the GUI 300 at a time t. The receiving computing device 110r can also receive the second received instant message 320 at a time (“time t+1”) after time t. Based on the second received instant message 320, the receiving computing device 110r will analyze the first received instant message 310 to determine if the first received instant message 310 includes a correctable error. A correctable error comprises a character, word, and/or phrase that differs from what is intended by the sending user 105s. Examples of a correctable error include, but are not limited to, a different word or phrase than an intended word or phrase, a punctuation mistake (e.g., indicating a question mark instead of an exclamation point), a misspelling or other form of typographical error, and the like. The receiving computing device 110r can determine that the first received instant message 310 includes a correctable error in various different ways, as described more fully below.

When the receiving computing device 110r determines that a correctable error is present in the first received instant message 310, a language model (such as language model 240) can be utilized to analyze each word of the first received instant message 310, based on the second received instant message 320, to determine an incorrect word to be corrected therein.

The language model 240 can take various different forms. As mentioned above, the language model 240 can be a probability distribution over a sequence of text (characters, word, phrases, etc.) that is derived from (or “trained” based on) training data. In some such implementations, the language model 240 can be configured to determine a language model score representative of a likelihood that a candidate (character, word, phrase, sentence, etc.) under analysis is correct for a given context (e.g., a character, word, phrase, sentence, etc. preceding and/or following the candidate).

In additional or alternative implementations, the language model 240 can be configured to determine an edit distance between a candidate and a character, word, phrase, sentence, etc. The term “edit distance” as used herein is intend to include any manner or technique for quantifying how similar/dissimilar two strings (character, word, phrase, sentence, etc.) are to one another, specifically including, but not limited, to the Levenshtein distance. As discussed below, a language model score and/or an edit distance can be utilized to not only determine whether the first received instant message 310 includes a correctable error, but also to determine the incorrect word therein and an appropriate corrected word to replace the incorrect word.

The receiving computing device 110r can also determine a corrected word to replace the incorrect word in the first received instant message 310, e.g., by utilizing the language model 240. The incorrect word can be replaced by the corrected word in the first received instant message 310 by the receiving computing device 110r to obtain a corrected first received instant message 330 (see FIG. 3C). As shown in FIG. 3C, the GUI 300 can be modified by the receiving computing device 110r such that the corrected first received instant message 330 replaces the first received instant message 310. In some implementations, the order, position, and/or format of the first received instant message 310 will be preserved such that the corrected first received instant message 330 will be identical to the first received instant message 310, except for the substitution of the incorrect word by the corrected word.

It should be appreciated that, while the modified GUI 300 shown in FIG. 3C is illustrated as not displaying the second received instant message 320 (as is shown in FIG. 3B), in some implementations, and based on the first and second received instant messages 310, 320, the modified GUI 300 may display both the corrected first received instant message 330 and the second received instant message 320. Additionally or alternatively, in certain implementations the receiving computing device 110r may utilize the second received instant message 320 for the sole purpose of correcting the first received instant message 310 such that the second received instant message 320 is never displayed by the GUI 300.

For example only, when the second received instant message 320 includes only one word, the receiving computing device 110r can select the one word as the corrected word to replace the incorrect word in the first received instant message 310, as described more fully below. In this example, the receiving computing device 110r can determine that the second received instant message 320 should be used for the sole purpose of correcting the first received instant message 310 such that the second received instant message 320 is never displayed by the GUI 300.

In yet another example, when the second received instant message 320 includes a string that includes a plurality of words in which a portion of the string is determined to be the corrected word, the receiving computing device 110r may also determine that the second received instant message 320 should be used for the sole purpose of correcting the first received instant message 310 such that the second received instant message 320 is never displayed by the GUI 300. For example only, for the first received instant message 310 stating “Can you send me a picture of your bat?” and the second received instant message 320 “of your cat,” the receiving computing device 110r can determine that the second received instant message 320 should be used for the sole purpose of correcting the first received instant message 310 and not be displayed.

It may be beneficial to provide an active indication to the receiving user 105r that the corrected first received instant message 330 has been corrected and differs from the first received instant message 310 that was originally received from the sending user 105s. Accordingly, with specific reference to FIG. 3D, the receiving computing device 110r can provide an active indication 335 that the corrected first received instant message 330 is a corrected version of the first received instant message 310. It should be appreciated that the inclusion of the active indication 335 is optional and may not be present in all implementations of the present disclosure.

The active indication 335 can be any distinctive marking or visual distinguisher that differentiates the corrected first received instant message 330 (or portion thereof) from the other instant messages (such as first and second received instant messages 310 and 320). Examples of an active indication 335 include, but are not limited to, modifying the format of the text of the corrected first received instant message 330 (bold, italics, different color, etc.) and/or position of the corrected first received instant message 330, modifying the appearance of the corrected first received instant message 330 (shaded, flashing, blinking, different color or changing colors, etc.), a morphing or other animation that demonstrates the correction being made to the first received instant message 310 in the GUI 300, or a combination thereof. Other active indications 335 are within the scope of the present disclosure.

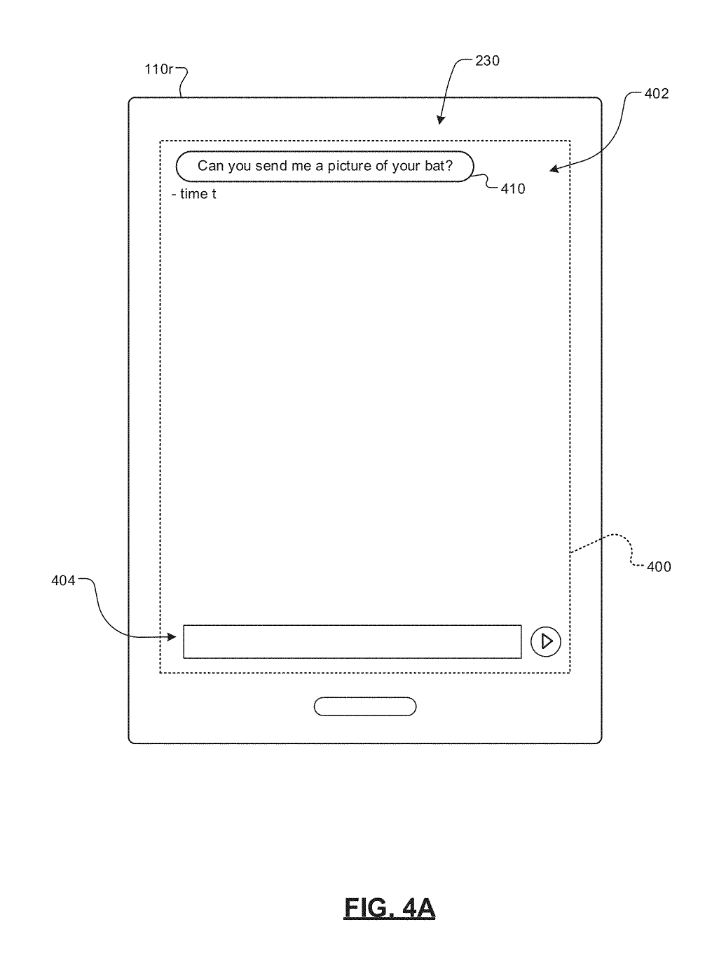

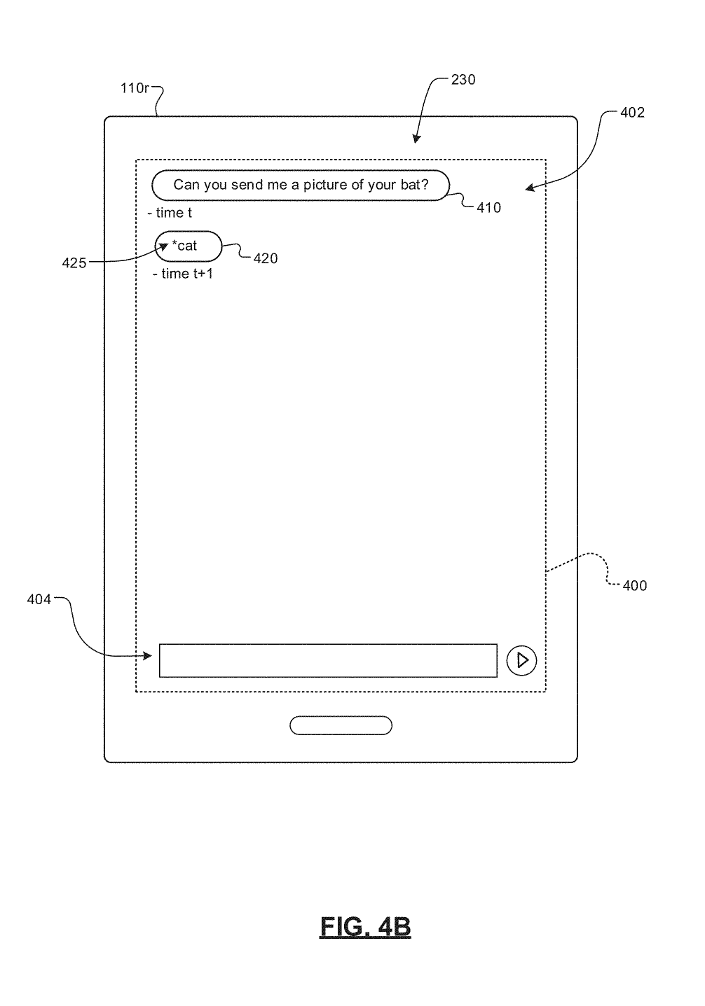

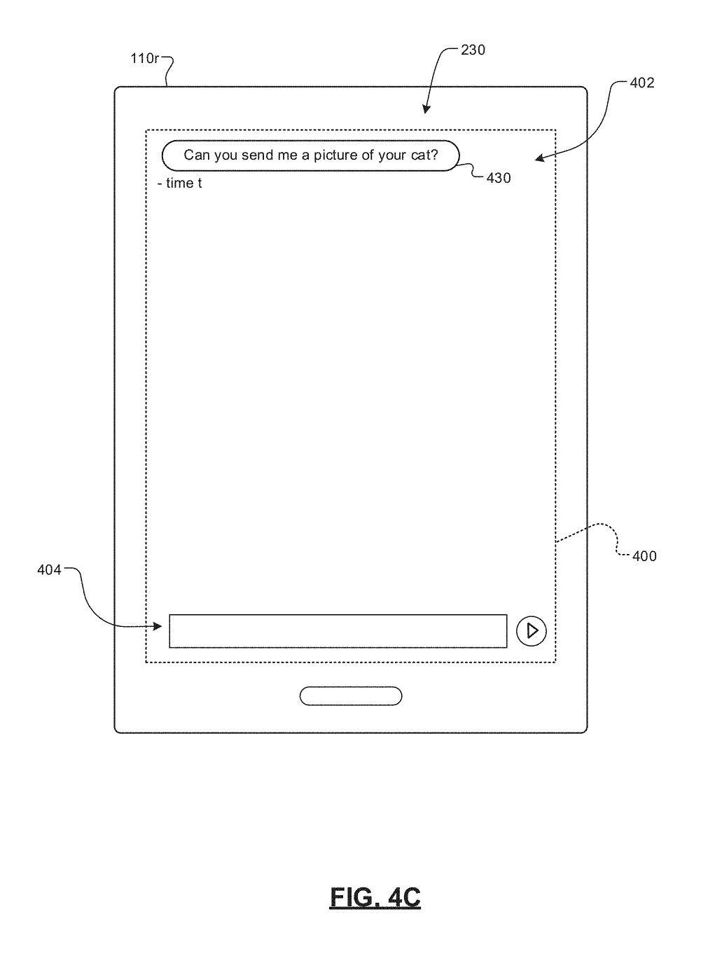

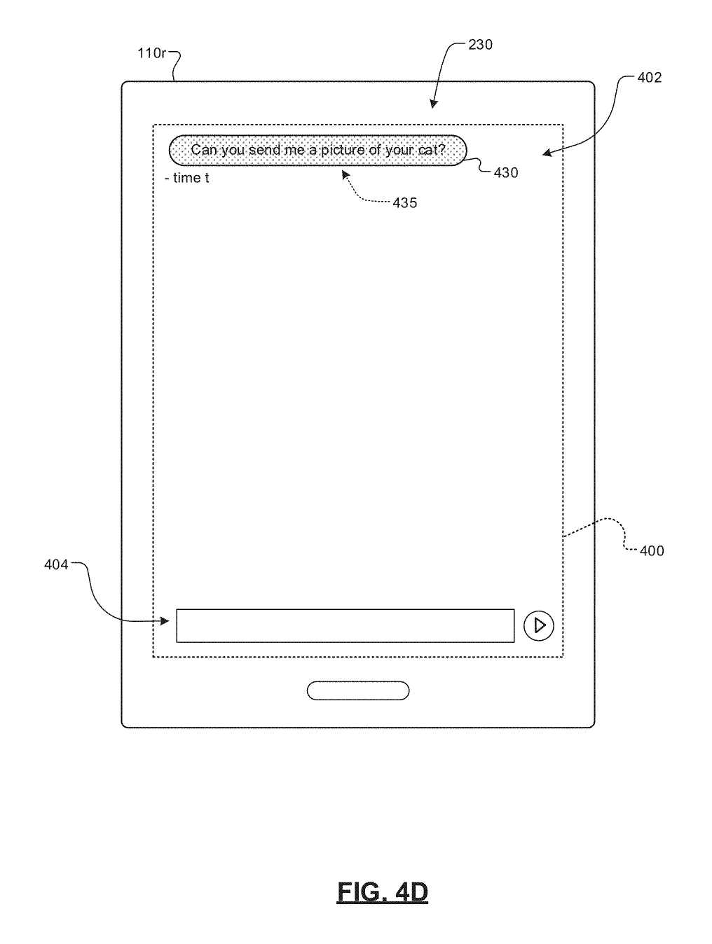

Another example of the instant message correction techniques of the present disclosure is illustrated in FIGS. 4A to 4D, in which an example GUI 400 is displayed by the display device 230 of the example receiving computing device 110r when executing the instant messaging application. The illustrated GUI 400 includes an instant message display portion 402 and an instant message input portion 404. Instant messages that are sent or received can be displayed in the instant message display portion 402, and a user 105 can provide textual or other input in the instant message input portion 404, e.g., via a virtual keyboard (not shown) or other user input device.

A first received instant message 410 can be received by the receiving computing device 110r. The first received instant message 410 can include one or more words. In the illustrated example, the first received instant message 410 is identical to the first received instant message 310 and includes the text content “Can you send me a picture of your bat?” The first received instant message 410 can be displayed in the instant message display portion 402. As in the above example, the sending user 105s may have intended the first received instant message 410 to read “Can you send me a picture of your cat?” instead of “bat” as sent. Noticing that the first received instant message 410 contains an error (“bat” instead of “cat”), the sending user 105s may transmit a second instant message (second received instant message 420) that reads “*cat” as shown in FIG. 4B.

In order for the receiving user 105r to correctly understand the first received instant message 410 as intended by the sending user 105s, the receiving user 105r must read both the first and second received instant messages 410, 420, deduce that the second received instant message 420 is intended as a correction to the first received instant message 410, and, in essence, replace the incorrect content (“bat”) of the first received instant message 410 with the corrected content (“cat”) in the second received instant message 420.

In the present example, the second received instant message 420 contains a user input correction indicator 425 (in this case, an asterisk—“*”) that can be indicative of an intent of the sending user 105s to correct the previously sent first received instant message 410. A user input correction indicator 425 as described herein comprises any character (or collection of characters) that indicates to the receiving computing device 110r and/or the receiving user 105r that a correction is intended by the sending user 105s. Such a user input correction indicator 425 may immediately precede and/or follow the corrected word that the sending user 105s intended to send. Examples of a user input correction indicator 425 include, but are not limited to, a correction word (“sorry,” “sry,” “typo,” “oops,” “whoops,” etc.) and/or one or more special characters. Examples of a special character include, but are not limited to, an asterisk, a front or backwards slash, a quotation mark or marks, a parenthesis or parentheses, an emoticon or emoji, and a combination thereof. In some implementations, the user input correction indicator 425 can additionally or alternatively comprise a repetition of one or more words from the first received instant message 410 preceding and/or following the corrected word. For example only, in the example of the first received instant message 310 (“Can you send me a picture of your bat?”) and the second received message 320 (“of your cat”), the computing device 110 can determine that the repeated words “of your” comprises a user input correction indicator 425. The use of a user input correction indicator 425/special character by the sending user 105s to indicate her/his intent to correct the previously sent first received instant message 410 can be leveraged by the receiving computing device 110r, as described more fully below.

In accordance with implementations of the present disclosure, the receiving computing device 110r will receive and display the first received instant message 410 in the GUI 400 at a time t. The receiving computing device 110r can also receive the second received instant message 420 at a time (“time t+1”) after time t. Although FIG. 4B illustrates implementations in which the second received instant message 420 is displayed (at least temporarily), in other implementations the second received instant message 420 may never be displayed, or may not be initially displayed without a specific user input from the receiving user 105r, and is utilized merely to correct the first received instant message 410.

Based on the second received instant message 420, the receiving computing device 110r will analyze the first received instant message 410 to determine if the first received instant message 410 includes a correctable error. As mentioned above, a correctable error comprises a character, word, and/or phrase that differs from what is intended by the sending user 105s. In the present example, the receiving computing device 110r can determine that the first received instant message 410 includes a correctable error by detecting the user input correction indicator 425, the special character (“*”). Furthermore, the user input correction indicator 425 may immediately precede and/or follow the word (“cat”) that the sending user 105s intended to send in the first received instant message 410, which is referred to herein as the user corrected word.

Upon determining that the first received instant message 410 includes the correctable error, the receiving computing device 110r can utilize a language model (such as language model 240) to analyze each word of the first received instant message 410, based on the second received instant message 420, to determine an incorrect word to be corrected therein.

As mentioned above, the language model 240 can take various different forms, e.g., the language model 240 can be configured to determine a language model score representative of a likelihood that a candidate (character, word, phrase, sentence, etc.) under analysis is correct for a given context (e.g., a character, word, phrase, sentence, etc. preceding and/or following the candidate) and/or be configured to determine an edit distance between a candidate and a character, word, phrase, sentence, etc. A language model score and/or an edit distance can be utilized to not only determine whether the first received instant message 410 includes a correctable error, but also to determine the incorrect word therein and an appropriate correct word to replace the incorrect word.

In the present example, and due to the detection of the user input correction indicator 425 in the second received instant message 420, the receiving computing device 110r can select the user corrected word (“cat”) as a corrected word to replace the incorrect word in the first received instant message 410. The receiving computing device 110r can also utilize the language model 240 to analyze each word of the first received instant message 410, based on the known corrected word (“cat”), to determine an incorrect word to be replaced by the corrected word. In some implementations, the language model 240 can be trained to determine that the word in the first received instant message 410 that corresponds to the shortest edit distance from, and/or has the highest replacement probability based on, the selected corrected word is the incorrect word.

The incorrect word can be replaced by the corrected word in the first received instant message 410 by the receiving computing device 110r to obtain a corrected first received instant message 430 (see FIG. 4C). As shown, the GUI 400 can be modified by the receiving computing device 110r such that the corrected first received instant message 430 replaces the first received instant message 410. In some implementations in which the second received instant message 420 is displayed, the modification of the GUI 400 can also include removing the second received instant message 420 from the user interface (see, e.g., FIG. 4C). In other implementations the second received instant message 420 may never be displayed, or may not be initially displayed without a specific user input from the receiving user 105r, and is utilized merely to correct the first received instant message 410.

Additionally, and as mentioned above, it may be beneficial to provide an active indication to the receiving user 105r that the corrected first received instant message 430 has been corrected and differs from the first received instant message 410 that was originally received from the sending user 105s. Accordingly, with specific reference to FIG. 4D, the receiving computing device 110r can provide an active indication 435 that the corrected first received instant message 430 is a corrected version of the first received instant message 410. The active indication 435 can be similar to the active indication 335 described above.

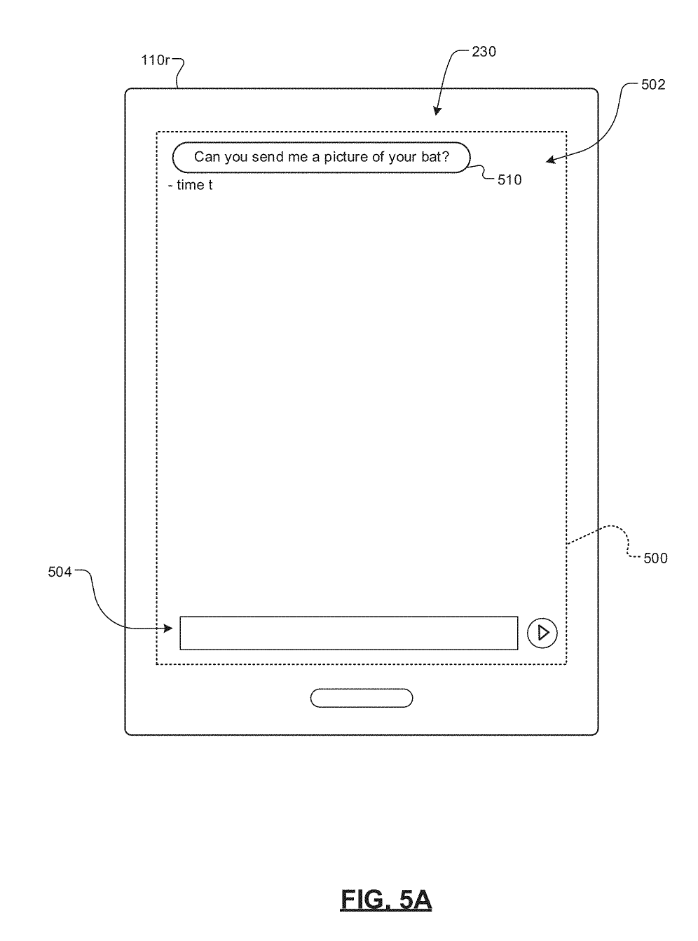

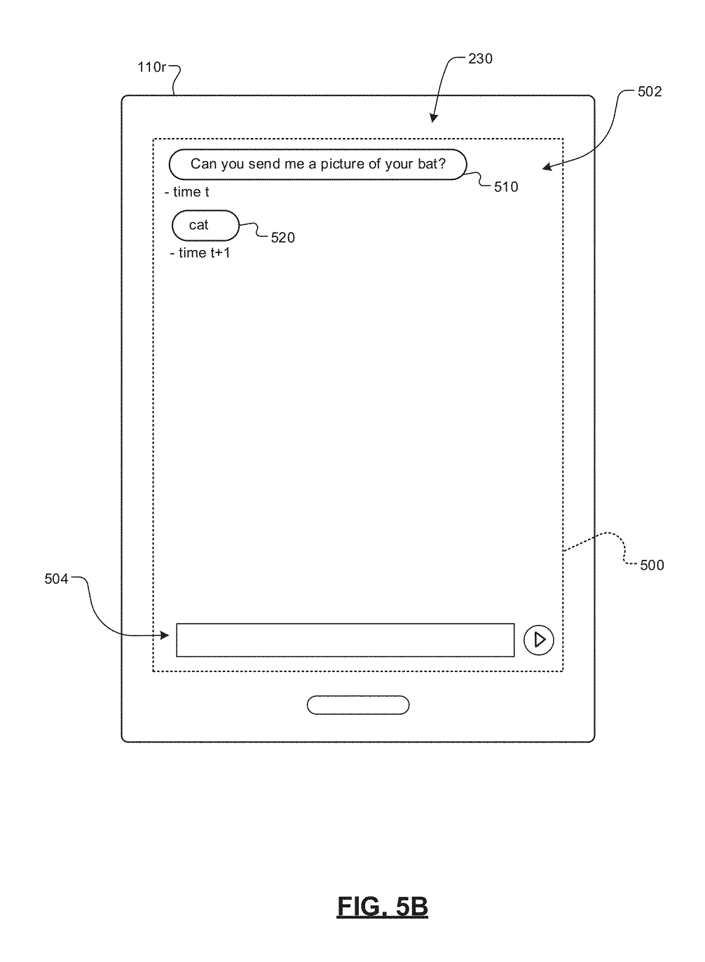

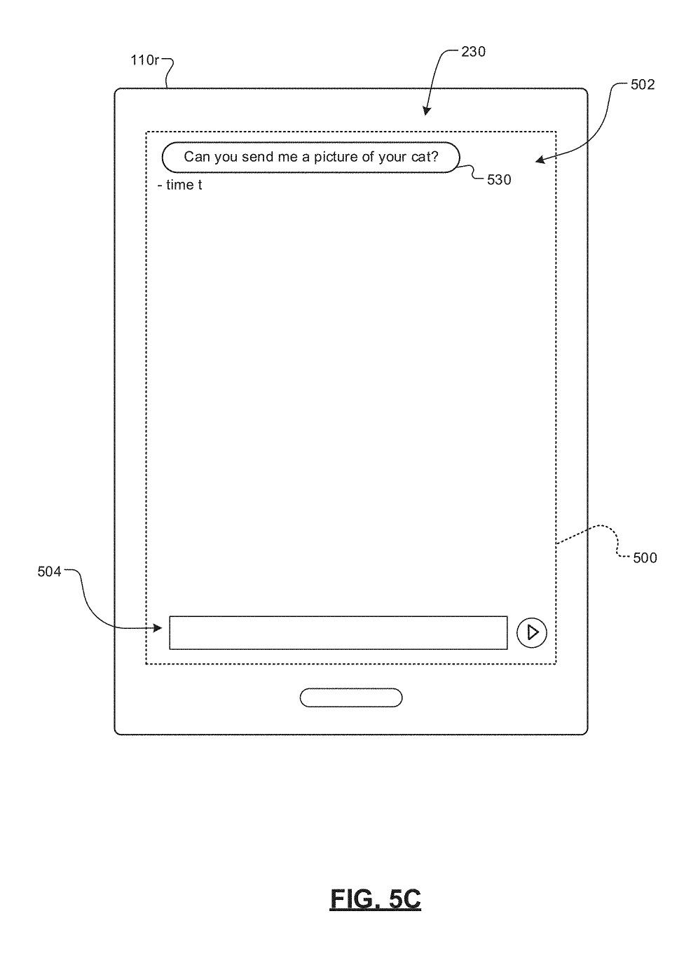

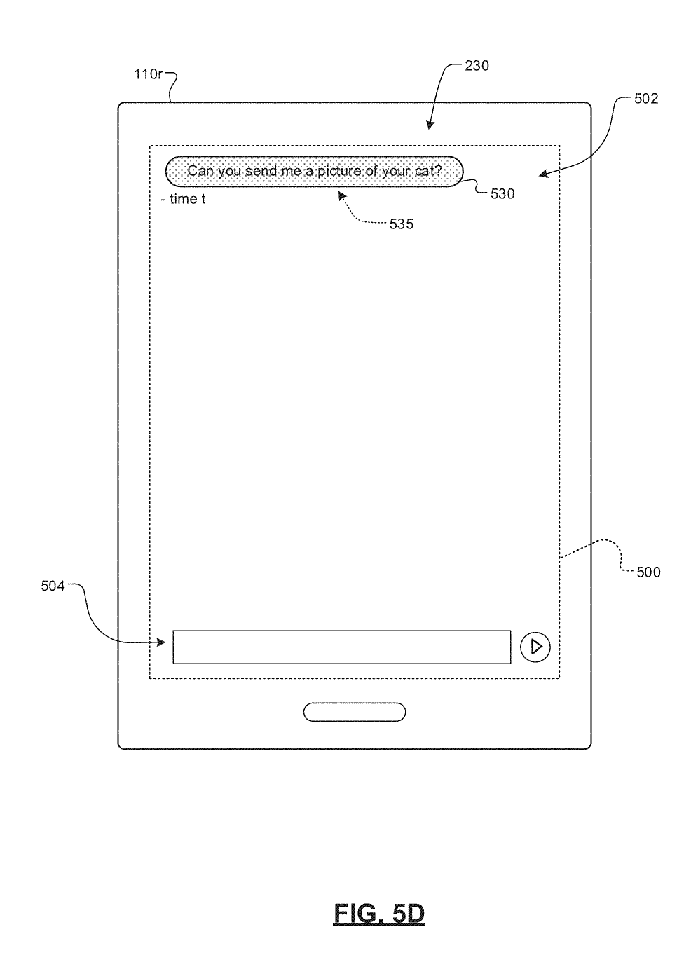

In a further example of the instant message correction techniques of the present disclosure, FIGS. 5A to 5D show an example GUI 500 that is displayed by the display device 230 of the example receiving computing device 110r when executing the instant messaging application. The illustrated GUI 500 includes an instant message display portion 502 and an instant message input portion 504. Instant messages that are sent or received can be displayed in the instant message display portion 502, and a user 105 can provide textual or other input in the instant message input portion 504, e.g., via a virtual keyboard (not shown) or other user input device.

A first received instant message 510 can be received by the receiving computing device 110r. The first received instant message 510 can include one or more words. In the illustrated example, the first received instant message 510 is identical to the first received instant messages 310, 410 and includes the text content “Can you send me a picture of your bat?” The first received instant message 510 can be displayed in the instant message display portion 502. As in the above example, the sending user 105s may have intended the first received instant message 510 to read “Can you send me a picture of your cat?” instead of “bat” as sent. Noticing that the first received instant message 510 contains an error (“bat” instead of “cat”), the sending user 105s may transmit a second instant message (second received instant message 520) that reads “cat” as shown in FIG. 5B.

In order for the receiving user 105r to correctly understand the first received instant message 510 as intended by the sending user 105s, the receiving user 105r must read both the first and second received instant messages 510, 520, deduce that the second received instant message 520 is intended as a correction to the first received instant message 510, and, in essence, replace the incorrect content (“bat”) of the first received instant message 510 with the corrected content (“cat”) in the second received instant message 520.

In the present example, the second received instant message 520 does not contain a user input correction indicator 425 as is described above in regard to FIG. 4B. In this case, the second received instant message 520 is one word (“cat”), which may also be indicative of an intent of the sending user 105s to correct the previously sent first received instant message 510. Accordingly, the receiving computing device 110r can determine an input error probability for at least one particular word of the first received instant message 510 based on the content (“cat”) of the second received instant message 520. Although the description of the input error probability is described in reference to at least one particular word, it should be appreciated that, in some implementations, each and every particular word of the first received instant message 510 can be analyzed.

The input error probability for a particular word corresponds to a likelihood that the sending user 105s inadvertently input the particular word when attempting to input a candidate word (in this example, “cat”). In some implementations, the input error probability is based on a typing model (which may be implemented in the language model 240) that associates an input sequence of characters to one or more typing candidates and a corresponding probability for each typing candidate. For example only, a typing model can provide each output candidate that a user, who is attempting to input a certain sequence of characters, will actually input and a corresponding probability for each output candidate.

For illustration purposes only, a user who is attempting to input “cat” on a keyboard may actually input a number of different output candidates (such as “cat”, “car”, “vat”, “bat”, and “far”) a certain percentage of the time. The above output candidates may be more likely than other candidates due to the proximity of the letter “c” to “v”, “b”, and “f” and the letter “t” to “r” in a standard keyboard. An example typing model may determine that a user attempting to input “cat” may input “cat” with a probability of X, “vat” with a probability of Y, and so on. Accordingly, the typing model and its associated input error probabilities can be leveraged by the receiving computing device 110r, as described herein.

The receiving computing device 110r can also utilize the language model 240 to determine a language model score for the first received instant message 510. In some implementations, the receiving computing device 110r can also utilize the language model 240 to determine one or more second language model scores for revised first received instant messages, where each revised first received instant message comprises the first received instant message 510 with the second received instant message 520 (the one word “cat” in this example) replacing a particular word therein. Examples of revised first received instant messages (based on the output candidates discussed above) can include:
Can you send me a picture of your cat?
Can you send me a picture of your vat?
Can you send me a picture of your car?
Can you send me a picture of your far?
   The determination of whether the first received instant message 510 includes a correctable error can be based on the input error probability, the language model score for the first received instant message 510, and at least one of the one or more second language model scores.

In accordance with implementations of the present disclosure, the receiving computing device 110r will receive and display the first received instant message 510 in the GUI 500 at a time t. The receiving computing device 110r can also receive the second received instant message 520 at a time (“time t+1”) after time t. Although FIG. 5B illustrates implementations in which the second received instant message 520 is displayed (at least temporarily), in other implementations the second received instant message 520 may never be displayed, or may not be initially displayed without a specific user input from the receiving user 105r, and is utilized merely to correct the first received instant message 510.

Upon determining that the first received instant message 510 includes the correctable error, the receiving computing device 110r can utilize a language model (such as language model 240) to analyze each word of the first received instant message 510, based on the second received instant message 520, to determine an incorrect word to be corrected therein.

The language model 240 can take various different forms and can be utilized to determine a language model score and/or an edit distance, as described above. As discussed below, a language model score and/or an edit distance can be utilized to not only determine whether the first received instant message 510 includes a correctable error, but also to determine the incorrect word therein and an appropriate correct word to replace the incorrect word.

In the present example, and due to the fact that the second received instant message 520 includes only one word, the receiving computing device 110r can select the one word (“cat”) as a corrected word to replace the incorrect word in the first received instant message 510. The receiving computing device 110r can also utilize the language model 240 to analyze each word of the first received instant message 510, based on the known corrected word (“cat”), to determine an incorrect word to be replaced by the corrected word. In some implementations, the language model 240 can be trained to determine that the word in the first received instant message 510 that corresponds to the shortest edit distance from, and/or has the highest replacement probability based on, the selected corrected word is the incorrect word.

The incorrect word can be replaced by the corrected word in the first received instant message 510 by the receiving computing device 110r to obtain a corrected first received instant message 530 (see FIG. 5C). As shown, the GUI 500 can be modified by the receiving computing device 110r such that the corrected first received instant message 530 replaces the first received instant message 510. In some implementations in which the second received instant message 520 is displayed, the modification of the GUI 500 can also include removing the second received textual message 520 (see, e.g., FIG. 5C). In other implementations, second received instant message 520 may never be displayed, or may not be initially displayed without a specific user input from the receiving user 105r, and is utilized merely to correct the first received textual message 510.

Additionally, and as mentioned above, it may be beneficial to provide an active indication to the receiving user 105r that the corrected first received instant message 530 has been corrected and differs from the first received instant message 510 that was originally received from the sending user 105s. Accordingly, with specific reference to FIG. 5D, the receiving computing device 110r can provide an active indication 535 that the corrected first received instant message 530 is a corrected version of the first received instant message 510. The active indication 535 can be similar to the active indications 335, 435 described above.

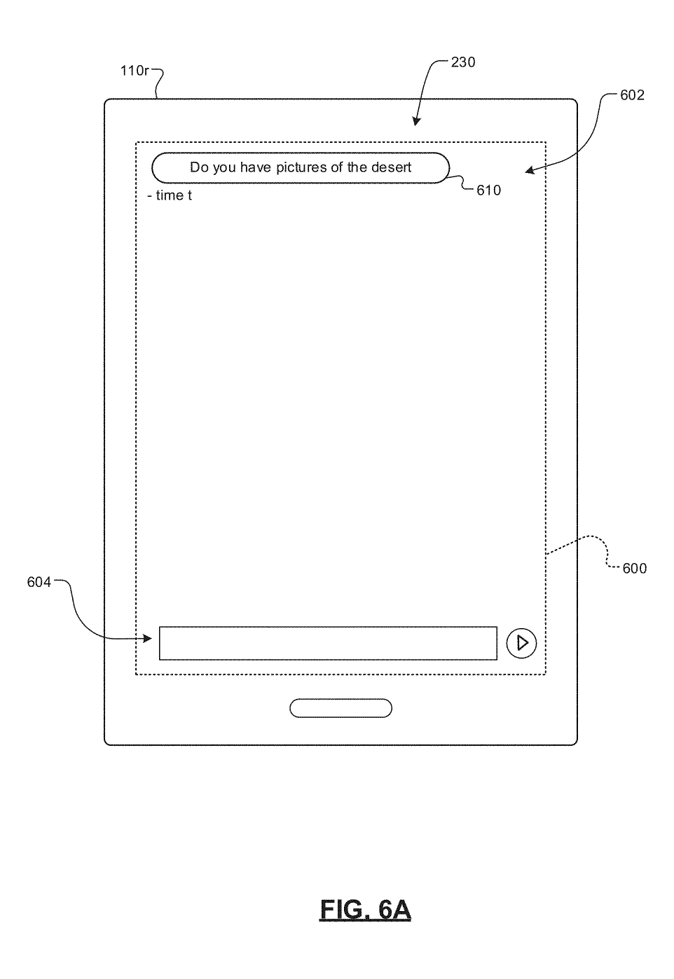

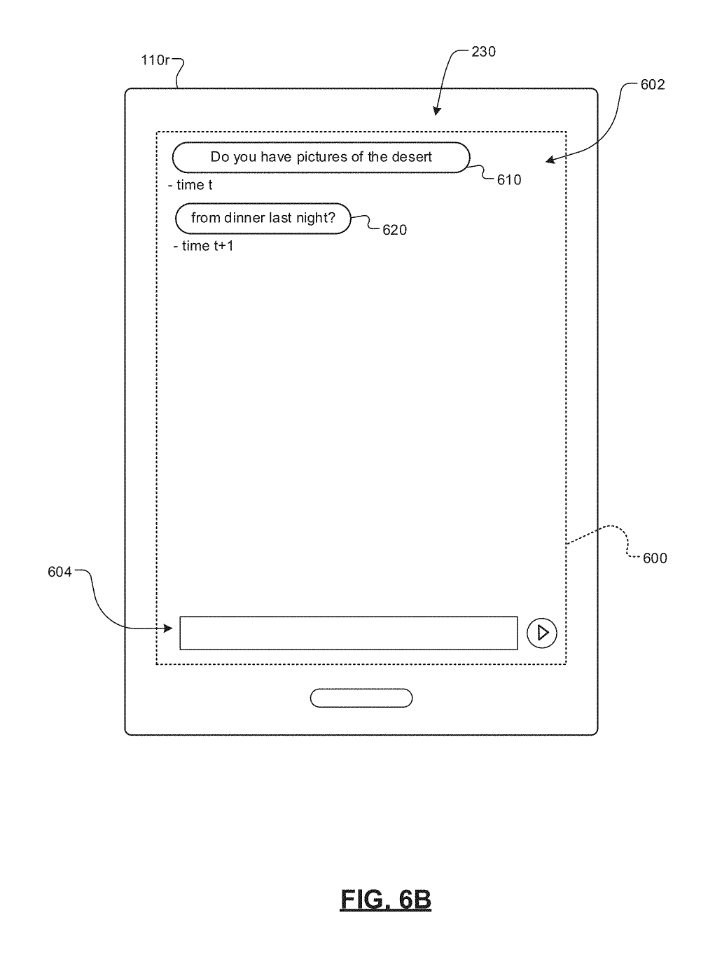

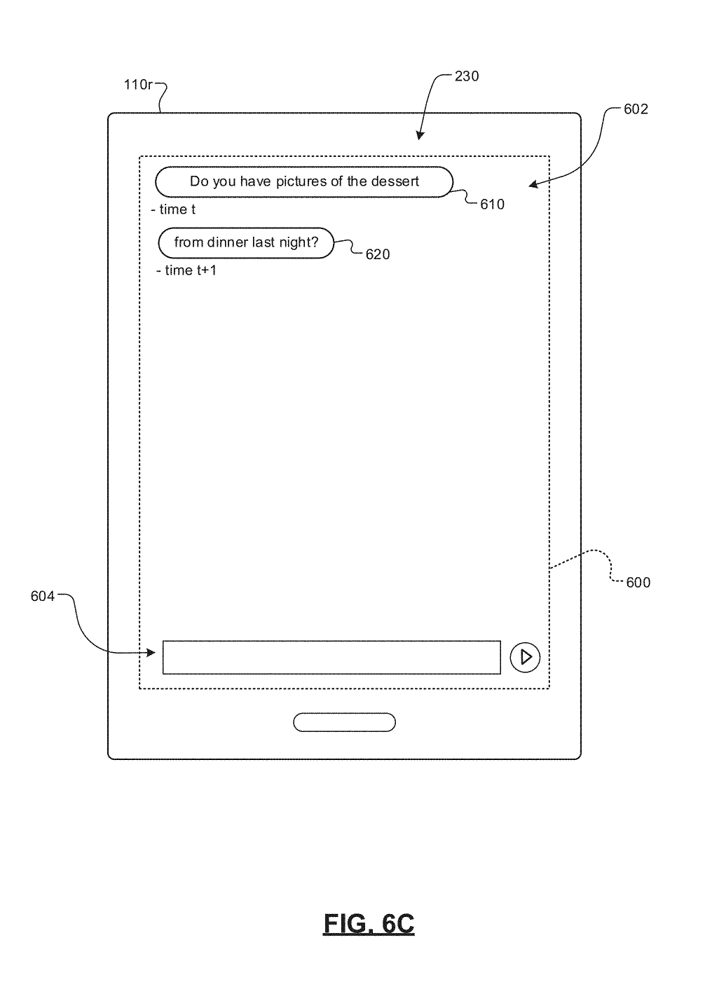

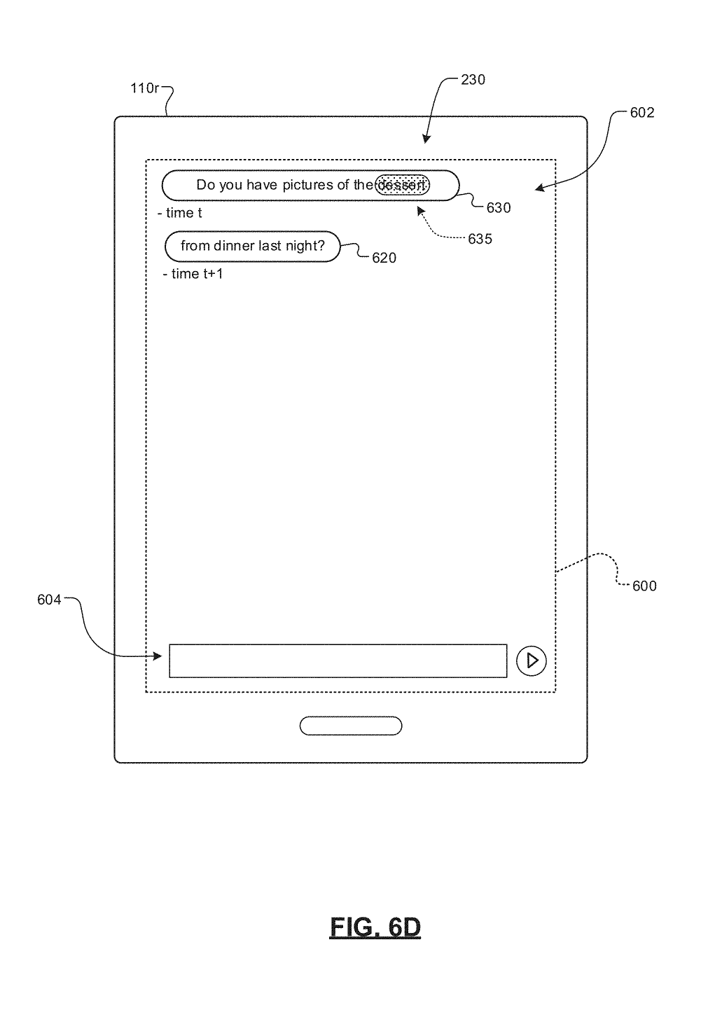

Yet another example of the instant message correction techniques of the present disclosure is illustrated in FIGS. 6A to 6D, in which an example GUI 600 is displayed by the display device 230 of the example receiving computing device 110r when executing the instant messaging application. The illustrated GUI 600 includes an instant message display portion 602 and an instant message input portion 604. Instant messages that are sent or received can be displayed in the instant message display portion 602, and a user 105 can provide textual or other input in the instant message input portion 604, e.g., via a virtual keyboard (not shown) or other user input device.

A first received instant message 610 can be received by the receiving computing device 110r. The first received instant message 610 can include one or more words. In the illustrated example, the first received instant message 610 includes the text content “Do you have pictures of the desert” and is associated with a timestamp of “time t.” The first received instant message 610 can be displayed in the instant message display portion 602. As in the above example, the sending user 105s may have inadvertently included a spelling or typographical error by misspelling the word “dessert” to instead read “desert” as sent. The sending user 105s also transmitted a second instant message (second received instant message 620) that reads “from dinner last night?” as shown in FIG. 6B.

In order for the receiving user 105r to correctly understand the first received instant message 610 as intended by the sending user 105s, the receiving user 105r must read both the first and second received instant messages 610, 620 and deduce that the sending user 105s meant “dessert” instead of “desert” as originally sent. In this example, the second received instant message 620 does not contain a user input correction indicator 425 as described above, and the sending user 105s may not even be aware of the incorrect word in the first receiving instant message 610.

In accordance with implementations of the present disclosure, the receiving computing device 110r will receive and display the first received instant message 610 in the GUI 400 at a time t. The receiving computing device 110r can also receive the second received instant message 620 at a time (“time t+1”) after time t. Based on the second received instant message 620, the receiving computing device 110r will analyze the first received instant message 610 to determine if the first received instant message 610 includes a correctable error. As mentioned above, a correctable error comprises a character, word, and/or phrase that differs from what is intended by the sending user 105s.

In the present example, the receiving computing device 110r can determine that the first received instant message 610 includes a correctable error by utilizing a language model (such as language model 240) to analyze the first and second received instant messages 610, 620. As mentioned above, the language model 240 can be utilized to determine a score (e.g., a language model score) or probability representative of a likelihood that a candidate (character, word, phrase, sentence, etc.) under analysis is correct for a given context (e.g., a character, word, phrase, sentence, etc. preceding and/or following the candidate). For example only, the receiving computing device 110r can utilize the language model 240 to determine a language model score for the message pair comprising the first received instant message 610 concatenated with the second received instant message 620. The receiving computing device 110r can determine that the first received instant message 610 includes a correctable error based on the language model score for the original message pair.

In some implementations, the receiving computing device 110r can compare the language model score for the original message pair to a threshold to determine if the first received instant message 610 includes a correctable error. The threshold may be selected such that a language model score that satisfies the threshold is indicative of relatively low likelihood that the first received instant message 610 includes a correctable error, and a language model score that does not satisfy the threshold is indicative of relatively high likelihood that the first received instant message 610 includes a correctable error.

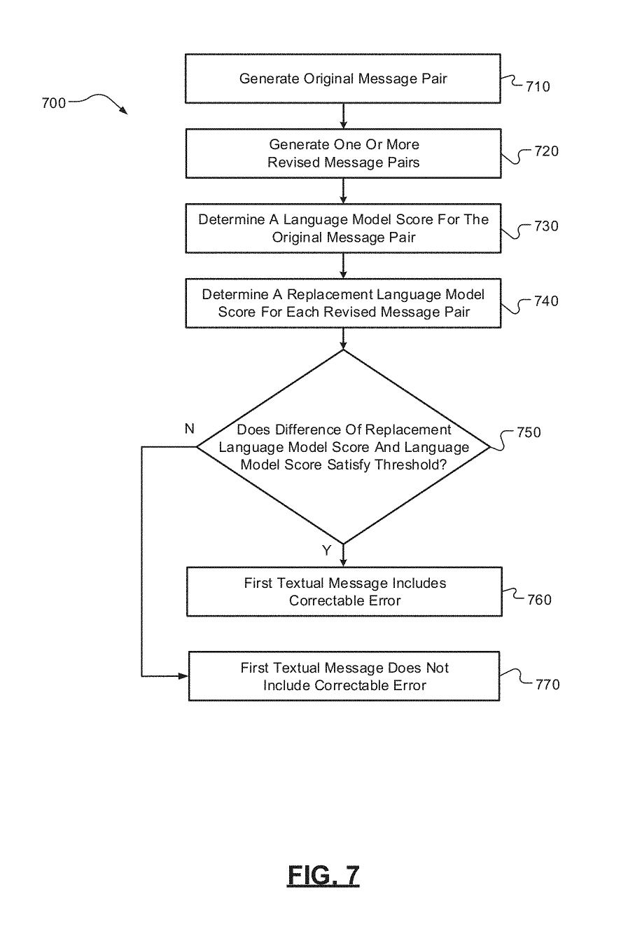

In additional or alternative implementations, and with further reference to FIG. 7, the language model score for the original message pair can be compared to the language model score for each of a plurality of revised message pairs. At 710, the first received instant message 610 can be concatenated with the second received instant message 620 to generate the original message pair. At 720, one or more revised message pairs can be generated. Each revised message pair can comprise the original message pair with at least one particular word of the first received instant message 610 replaced by a potential replacement candidate. It should be appreciated that each word of the first received instant message 610 can be analyzed, or only some of the words can be analyzed, depending on the implementation.

The receiving computing device 110r can determine one or more potential replacement candidates for a particular word of the first received instant message 610, e.g., by selecting any word with a low edit distance from the particular word and/or a high replacement probability as a potential replacement candidate for the particular word. For example only, in the example of FIGS. 6A-6D, the original message pair [“Do you have pictures of the desert,” “from dinner last night”] can be modified to generate a revised message pair [“Do you have pictures of the dessert,” “from dinner last night”]. In this manner, the one or more potential replacement candidates for the particular word of the one or more words of the first received instant message 610 can include any words (“dessert”) with an edit distance from the particular word (“desert”) that satisfies an edit distance threshold or a replacement probability that satisfies a replacement probability threshold. Each of the edit distance threshold and the replacement probability threshold can be selected through training, e.g., by machine learning, and can be based on various aspects of the language model.

The receiving computing device 110r can utilize the language model 240 to compute a language model score for the original message pair (730) and a replacement language model score for each revised message pair (740). Further, the receiving computing device 110r can compare (750) the language model score for the original message pair with each of the replacement language model scores. Continuing with the example above, the language model score for the original message pair [“Do you have pictures of the desert,” “from dinner last night”] may be 0.27 and the replacement language model score for the revised message pair [“Do you have pictures of the dessert,” “from dinner last night”] may be 0.34.

In some implementations, the receiving computing device 110r can determine that the first received instant message 610 includes a correctable error (760) when a difference between a particular one of the replacement language model scores (0.34) and the language model score (0.27) for the original message pair satisfies a threshold, e.g., a particular one of the replacement language model scores exceeds the language model score for the original message pair by an amount that satisfies a difference threshold (e.g., 0.05). In the above example, the particular one of the replacement language model scores (0.34) that exceeds the language model score (0.27) for the original message pair by an amount that satisfies the difference threshold (0.05) will correspond to: (i) a particular original word (“desert”) in the first received instant message 610, and (ii) a particular replacement candidate (“dessert”). In the event that the comparison (750) of the language model score for the original message pair with each of the replacement language model scores does not satisfy the threshold, it can be determined (770) that the first textual message does not include a correctable error.

Upon determining that the first received instant message 610 includes the correctable error, the receiving computing device 110r can utilize the language model 240 to determine an incorrect word to be corrected in the first received instant message 610 and a corrected word to replace the incorrect word. In some implementations, the receiving computing device 110r will select the particular original word as the incorrect word and/or the particular replacement candidate as the corrected word. In this manner, the receiving computing device can replace the incorrect word in the first received message 610 with the corrected word to obtain a corrected first received instant message 630, and modify the user interface 600 such that the corrected first received instant message 630 replaces the first received instant message 610 (see FIG. 6C).

Additionally, and as mentioned above, it may be beneficial to provide an active indication to the receiving user 105r that the corrected first received instant message 630 has been corrected and differs from the first received instant message 610 that was originally received from the sending user 105s. Accordingly, with specific reference to FIG. 6D, the receiving computing device 110r can provide an active indication 635 that the corrected first received instant message 630 is a corrected version of the first received instant message 610. The active indication 635 can be similar to the active indications 335, 435, 535 described above. The active indication 635 illustrated in FIG. 6D differs from the active indications 335, 435, 535 in that active indication 635 is associated only with the corrected portion (e.g., word) of the corrected first received instant message 630.

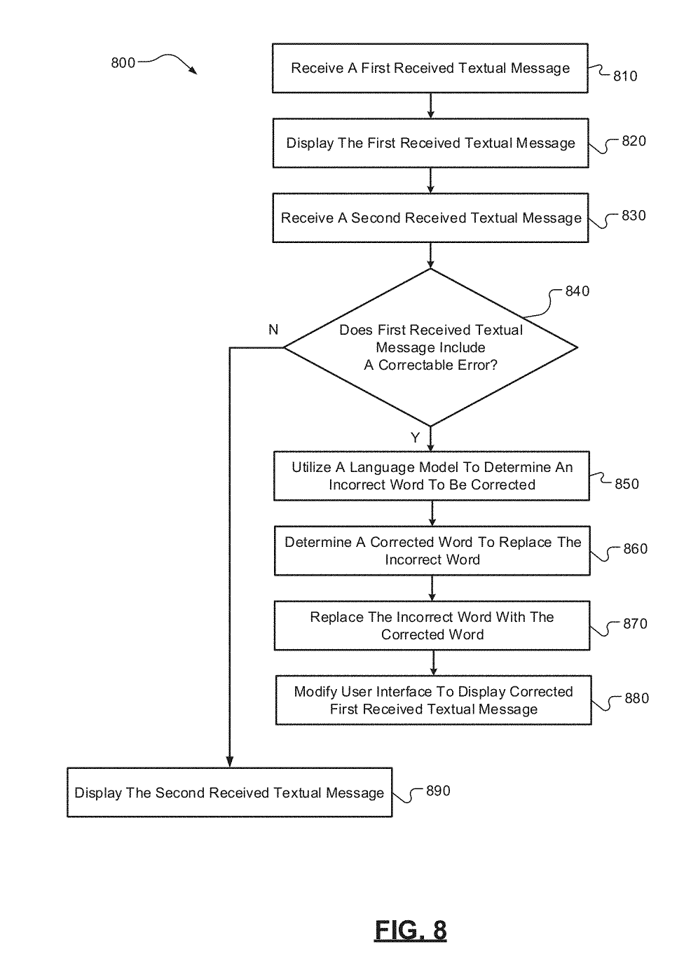

Referring now to FIG. 8, a flow diagram of an example technique 800 for correcting previously received instant messages based on a later received instant message is illustrated. While the technique 800 will be described below as being performed by a computing device 110, it should be appreciated that the technique 800 can be performed, in whole or in part, at another or more than one computing device and/or the server 120 described above.

At 810, an instant message (such as first received instant message 310, 410, 510, and 610) is received by a computing device 110 (e.g., receiving computing device 110r). The first received instant message is displayed at 820, e.g., on the display device 230, and a second received instant message (such as second received instant message 320, 420, 520, and 620) is received at 830. The computing device 110 determines (at 840) whether the first received instant message includes a correctable error based on the second received instant message. As described above, whether the first received instant message includes a correctable error based on the second received instant message can be determined in various different manners, which will not repeated here. If it is determined that the first received instant message does not include a correctable error, the second received instant message is displayed at 890, e.g., on the display device 230.

If, however, it is determined at 840 that the first received instant message does include a correctable error, the technique 800 continues to 850 at which the computing device 110 utilizes a language model to determine an incorrect word in the first received instant message to be corrected. At 860, the computing device 110 also determines a corrected word to replace the incorrect word. The determination of the incorrect word and the corrected word can each be performed in the various manners discussed above. The computing device 110 can replace the incorrect word with the corrected word (at 870) in the first received instant message to obtain a corrected first received instant message. Finally, at 880, the computing device 110 can modify the user interface (such as GUI 300, 400, 500, 600) such that the corrected first received instant message replaces the first received instant message.

Each of the descriptions above generally relate to a single message pair comprising a first received instant/textual message and a second (later) received instant/textual message, where the second received instant message can be utilized to determine and correct a correctable error in the first received instant message. It should be appreciated, however, that the described techniques can be applied, mutatis mutandis, to correcting one or more first received instant messages based on one or more second received instant messages. For example only, a second received instant message can be utilized to correct the same (or a different) correctable error in two previously received instant messages at the same time. Similarly, two (or more) second received instant messages can be utilized to correct a correctable error in one (or more) previously received instant messages at the same time

Additionally or alternatively, a second received instant message can be utilized correct to a correctable error in a previously received first instant message to obtain a corrected first received instant message, which can then be utilized to correct an even earlier received instant message in a recursive process to correct multiple instant messages consecutively in a “domino” effect. Similarly, two (or more) second received instant messages can be utilized correct to a correctable error in one (or more) previously received first instant message(s) to obtain one (or more) corrected first received instant message(s), which can then be utilized to correct one or more even earlier received instant message(s) recursively.

Further to the descriptions above, a user may be provided with controls allowing the user to make an election as to both if and when systems, applications, or features described herein may enable collection of user information (information about a user's current location, information extracted from the exchanged audio data, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in various different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in one or more ways. Such variations are not to be regarded as a departure from the disclosure, and all such modifications are intended to be included within the scope of the disclosure.

1. A computer-implemented method, comprising:
receiving, at a computing device executing a communication application, a first received textual message sent by a sender user at a first time during a communication session, the first received textual message including one or more words;
displaying, at the computing device, the first received textual message in a user interface of the communication application;
receiving, at the computing device, a second received textual message sent by the sender user at a second time after the first time during the communication session;
determining, at the computing device and based on the second received textual message, if the first received textual message includes a correctable error, wherein determining if the first received textual message includes the correctable error comprises:
concatenating the first received textual message with the second received textual message to obtain a message pair;
utilizing the language model to compute a language model score for the message pair; and
for at least one particular word of the one or more words of the first received textual message:
determining one or more potential replacement candidates,
replacing the particular word with each replacement candidate of the one or more potential replacement candidates in the message pair to obtain a revised message pair for each replacement candidate,
utilizing the language model to compute a replacement language model score for each revised message pair, and
comparing each replacement language model score with the language model score for the message pair; and
when the first received textual message includes the correctable error:
utilizing, at the computing device, a language model to analyze at least one word of the one or more words of the first received textual message based on the second received textual message to determine an incorrect word to be corrected,
determining, at the computing device and based on the second received textual message, a corrected word to replace the incorrect word,
replacing, at the computing device, the incorrect word in the first received message with the corrected word to obtain a corrected first received textual message, and
modifying, at the computing device, the user interface such that the corrected first received textual message replaces the first received textual message.

2-5. (canceled)

6. The computer-implemented method of claim 1, wherein the first received textual message is determined to include the correctable error when a particular one of the replacement language model scores exceeds the language model score for the message pair by an amount that satisfies a difference threshold.

7. The computer-implemented method of claim 6, wherein:
the particular one of the replacement language model scores corresponds to a particular potential replacement candidate of the one or more potential replacement candidates; and
determining the corrected word to replace the incorrect word comprises selecting the particular potential replacement candidate as the corrected word.

8. The computer-implemented method of claim 1, wherein the one or more potential replacement candidates for the particular word of the one or more words of the first received textual message includes any words with an edit distance from the particular word that satisfies an edit distance threshold or a replacement probability that satisfies a replacement probability threshold.

9-10. (canceled)

11. The computer-implemented method of claim 1, further comprising:
displaying, at the computing device, the second received textual message in the user interface,
wherein modifying the user interface includes removing the second received textual message from the user interface.

12. A computing device, comprising:
one or more processors; and
a non-transitory computer-readable storage medium having a plurality of instructions stored thereon, which, when executed by the one or more processors, cause the one or more processors to perform operations comprising:
executing an communication application;
receiving a first received textual message from a sender user at a first time during a communication session, the first received textual message including one or more words;
displaying the first received textual message in a user interface of the communication application;
receiving a second received textual message from the sender user at a second time after the first time during the communication session;
determining, based on the second received textual message, if the first received textual message includes a correctable error, wherein determining if the first received textual message includes the correctable error comprises:
concatenating the first received textual message with the second received textual message to obtain a message pair;
utilizing the language model to compute a language model score for the message pair; and
for at least one particular word of the one or more words of the first received textual message:
determining one or more potential replacement candidates,
replacing the particular word with each replacement candidate of the one or more potential replacement candidates in the message pair to obtain a revised message pair for each replacement candidate,
utilizing the language model to compute a replacement language model score for each revised message pair, and
comparing each replacement language model score with the language model score for the message pair; and
when the first received textual message includes the correctable error:
utilizing a language model to analyze each word of the one or more words of the first received textual message based on the second received textual message to determine an incorrect word to be corrected,
determining, based on the second received textual message, a corrected word to replace the incorrect word,
replacing the incorrect word in the first received message with the corrected word to obtain a corrected first received textual message, and
modifying the user interface such that the corrected first received textual message replaces the first received textual message.

13-16. (canceled)

17. The computing device of claim 12, wherein the first received textual message Is determined to include the correctable error when a particular one of the replacement language model scores exceeds the language model score for the message pair by an amount that satisfies a difference threshold.

18. The computing device of claim 17, wherein:
the particular one of the replacement language model scores corresponds to a particular potential replacement candidate of the one or more potential replacement candidates; and
determining the corrected word to replace the incorrect word comprises selecting the particular potential replacement candidate as the corrected word.

19. The computing device of claim 12, wherein the one or more potential replacement candidates for the particular word of the one or more words of the first received textual message includes any words with an edit distance from the particular word that satisfies an edit distance threshold or a replacement probability that satisfies a replacement probability threshold.

20-21. (canceled)

22. The computing device of claim 12, wherein the operations further comprise displaying the second received textual message in the user interface, wherein modifying the user interface includes removing the second received textual message from the user interface.

23. A non-transitory computer-readable storage medium having a plurality of instructions stored thereon, which, when executed by one or more processors, cause the one or more processors to perform operations comprising:
executing an communication application;
receiving a first received textual message from a sender user at a first time during a communication session, the first received textual message including one or more words;
displaying the first received textual message in a user interface of the communication application;
receiving a second received textual message from the sender user at a second time after the first time during the communication session;
determining, based on the second received textual message, if the first received textual message includes a correctable error, wherein determining if the first received textual message includes the correctable error comprises:
concatenating the first received textual message with the second received textual message to obtain a message pair;
utilizing the language model to compute a language model score for the message pair; and
for at least one particular word of the one or more words of the first received textual message:
determining one or more potential replacement candidates,
replacing the particular word with each replacement candidate of the one or more potential replacement candidates in the message pair to obtain a revised message pair for each replacement candidate,
utilizing the language model to compute a replacement language model score for each revised message pair, and
comparing each replacement language model score with the language model score for the message pair; and
when the first received textual message includes the correctable error:
utilizing a language model to analyze each word of the one or more words of the first received textual message based on the second received textual message to determine an incorrect word to be corrected,
determining, based on the second received textual message, a corrected word to replace the incorrect word,
replacing the incorrect word in the first received message with the corrected word to obtain a corrected first received textual message, and
modifying the user interface such that the corrected first received textual message replaces the first received textual message.

24. The computer-readable storage medium of claim 23, wherein the first received textual message is determined to include the correctable error when a particular one of the replacement language model scores exceeds the language model score for the message pair by an amount that satisfies a difference threshold.

25. The computer-readable storage medium of claim 24, wherein:
the particular one of the replacement language model scores corresponds to a particular potential replacement candidate of the one or more potential replacement candidates; and
determining the corrected word to replace the incorrect word comprises selecting the particular potential replacement candidate as the corrected word.

26. The computer-readable storage medium of claim 23, wherein the one or more potential replacement candidates for the particular word of the one or more words of the first received textual message includes any words with an edit distance from the particular word that satisfies an edit distance threshold or a replacement probability that satisfies a replacement probability threshold.

27. The computer-readable storage medium of claim 23, wherein the operations further comprise displaying, at the computing device, the second received textual message in the user interface, wherein modifying the user interface includes removing the second received textual message from the user interface.

28. The computer-implemented method of claim 1, further comprising:
utilizing, at the computing device, the corrected first received textual message to determine if a preceding received textual message that is sent by the sender user at a time preceding the first time includes another correctable error; and
correcting the preceding received textual message when the preceding received textual message includes the other correctable error.

29. The computer-implemented method of claim 28, wherein correcting the preceding received textual message when the preceding received textual message includes the other correctable error comprises:
utilizing, at the computing device, the language model to analyze at least one word of the preceding received textual message based on the corrected first received textual message to determine another incorrect word to be corrected,
determining, at the computing device and based on the corrected first received textual message, another corrected word to replace the other incorrect word,
replacing, at the computing device, the other incorrect word in the preceding received textual message with the other corrected word to obtain a corrected preceding received textual message, and
modifying, at the computing device, the user interface such that the corrected preceding received textual message replaces the preceding received textual message.

30. The computer-implemented method of claim 1, further comprising:
determining, at the computing device and based on the corrected first received textual message, if a preceding received textual message includes another correctable error, the preceding received textual message being sent by the sender user at a time preceding the first time;
when the preceding received textual message includes the other correctable error:
utilizing, at the computing device, the language model to analyze at least one word of the preceding received textual message based on the corrected first received textual message to determine another incorrect word to be corrected,
determining, at the computing device and based on the corrected first received textual message, another corrected word to replace the other incorrect word,
replacing, at the computing device, the other incorrect word in preceding received textual message with the other corrected word to obtain a corrected preceding received textual message, and
modifying, at the computing device, the user interface such that the corrected preceding received textual message replaces the preceding received textual message.

31. The computing device of claim 12, wherein the operations further comprise:
utilizing, at the computing device, the corrected first received textual message to determine if a preceding received textual message that is sent by the sender user at a time preceding the first time includes another correctable error; and
correcting the preceding received textual message when the preceding received textual message includes the other correctable error.

32. The computing device of claim 31, wherein correcting the preceding received textual message when the preceding received textual message includes the other correctable error comprises:
utilizing, at the computing device, the language model to analyze at least one word of the preceding received textual message based on the corrected first received textual message to determine another incorrect word to be corrected,
determining, at the computing device and based on the corrected first received textual message, another corrected word to replace the other incorrect word,
replacing, at the computing device, the other incorrect word in the preceding received textual message with the other corrected word to obtain a corrected preceding received textual message, and
modifying, at the computing device, the user interface such that the corrected preceding received textual message replaces the preceding received textual message.

33. The computing device of claim 12, wherein the operations further comprise:
determining, at the computing device and based on the corrected first received textual message, if a preceding received textual message includes another correctable error, the preceding received textual message being sent by the sender user at a time preceding the first time;
when the preceding received textual message includes the other correctable error:
utilizing, at the computing device, the language model to analyze at least one word of the preceding received textual message based on the corrected first received textual message to determine another incorrect word to be corrected,
determining, at the computing device and based on the corrected first received textual message, another corrected word to replace the other incorrect word,
replacing, at the computing device, the other incorrect word in preceding received textual message with the other corrected word to obtain a corrected preceding received textual message, and
modifying, at the computing device, the user interface such that the corrected preceding received textual message replaces the preceding received textual message.

34. The computer-readable storage medium of claim 23, wherein the operations further comprise:
utilizing, at the computing device, the corrected first received textual message to determine if a preceding received textual message that is sent by the sender user at a time preceding the first time includes another correctable error; and
correcting the preceding received textual message when the preceding received textual message includes the other correctable error.

35. The computer-readable storage medium of claim 23, wherein the operations further comprise:
determining, at the computing device and based on the corrected first received textual message, if a preceding received textual message includes another correctable error, the preceding received textual message being sent by the sender user at a time preceding the first time;
when the preceding received textual message includes the other correctable error:
utilizing, at the computing device, the language model to analyze at least one word of the preceding received textual message based on the corrected first received textual message to determine another incorrect word to be corrected,
determining, at the computing device and based on the corrected first received textual message, another corrected word to replace the other incorrect word,
replacing, at the computing device, the other incorrect word in preceding received textual message with the other corrected word to obtain a corrected preceding received textual message, and
modifying, at the computing device, the user interface such that the corrected preceding received textual message replaces the preceding received textual message.
